(19) United States
(12) Patent Application Publication
(10) Pub. No.: US 2009/0142117 A1
(43) Pub. Date: Jun. 4, 2009

(54) KEYBOARD WITH EXTENDED CONNECTION

(75) Inventors: Poo Dee CHOO, Singapore (SG); Ming Tat CHAN, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd, Singapore (SG)

(21) Appl. No.: 12/365,868

(22) Filed: Feb. 4, 2009

Related U.S. Application Data
(62) Division of application No. 11/209,516, filed on Aug. 22, 2005.

(51) Int. Cl. B41J 5/00; G06F 3/02

(52) U.S. Cl. 400/472; 345/168

(57) ABSTRACT

A keyboard for use with a host computer is disclosed. The keyboard has a main portion with a processor and a driver; and an auxiliary portion releasably connected to the main portion and being operatively connected to the processor by a cable. The processor and the driver of the main portion are used for the operation of the auxiliary portion.

### CROSS REFERENCE TO OTHER APPLICATIONS

This application is a divisional of co-pending U.S. patent application Ser. No. 11/209,516 (Attorney Docket No. CTLP110US), entitled KEYBOARD WITH EXTENDED CONNECTION, filed Aug. 22, 2005, which is incorporated herein by reference for all purposes.

Additionally, reference is made to U.S. patent application Ser. No. 10/640,210 (Attorney Docket No. 006404.P009), entitled KEYBOARD WITH BUILT-IN MICROPHONE filed Aug. 12, 2003, now patented as U.S. Pat. No. 6,935,797 B2, the contents of which are hereby incorporated in their entirety by reference.

### FIELD OF THE INVENTION

This invention relates to a keyboard with an extended connection and refers particularly, though not exclusively, to a keyboard with at least one extended keypad formation.

### BACKGROUND OF THE INVENTION

The standard alphanumeric keyboard has at least 104 keys. These normally include a main alphanumeric keypad, a smaller keypad (normally on the right of the main keyboard) with about ten cursor control keys, a numeric keypad on the extreme right-hand side, and several function keys in a row across the top. All keys have known, and fixed functions. If extra functions are required, either the keyboard is reprogrammed (a task beyond most people) or extra devices added using, for example, USB ports on the host computer. This is inefficient and clutters the surface on which the keyboard is placed.

### SUMMARY OF THE INVENTION

In accordance with a first preferred aspect there is provided a keyboard for use with a host computer. The keyboard comprises a main portion comprising a processor and a driver; and an auxiliary portion releasably connectable to the main portion and being operatively connectable to the processor and the driver by a cable. The processor and the driver of the main portion are usable for operation of the auxiliary portion.

The auxiliary portion does not have processor and driver. All power for the auxiliary portion is from the main portion via the cable. The keyboard may have at least one latch for releasably attaching the auxiliary portion to the main portion. The auxiliary portion may have one or more of: a plurality of keys, a games console, a sound generation device, a touchpad, a trackball and a joystick.

The main portion may have a wireless interface, a transceiver and an antenna for communication wirelessly with the host computer and for communicating wireless with at least one peripheral device. The communication with the host computer may be at a first bandwidth and the communication with the at least one peripheral device may be at a second bandwidth. The second bandwidth may be less than the first bandwidth

The communication with the host computer may be at a first frequency, and the communication with the at least one peripheral device may be at a second frequency. The first frequency may be greater than the second frequency.

The first frequency may be in the range 5 GHz to 5.2 GHz and the second frequency may be in the range 27 MHz to 49 MHz. The first bandwidth may be 480 MB/s.

According to a second aspect there is provided an auxiliary portion of a keyboard for releasable and operative attachment to a main keyboard portion, the operative attachment being by a cable. The main keyboard portion has a processor and a driver that are usable for operation of the auxiliary portion via the cable.

For the second aspect, the auxiliary portion may not have processor and driver. All power for the auxiliary portion is from the main portion via the cable. At least one latch may be provided for releasably attaching the auxiliary portion to the main portion. The auxiliary portion may have one or more of: a plurality of keys, a games console, a sound generation device, a touchpad, a trackball and a joystick.

According to a third preferred aspect there is provided a keyboard for use with a host computer, the keyboard comprising a wireless interface, a transceiver, and an antenna, for communication wirelessly with the host computer and for communicating wirelessly with at least one peripheral device. The communication with the host computer is at a first bandwidth and the communication with the at least one peripheral device is at a second bandwidth. The second bandwidth is less than the first bandwidth

The communication with the host computer may be at a first frequency and the communication with the at least one peripheral device may be at a second frequency. The first frequency may be greater than the second frequency. The keyboard may be able to be used as a hub for wireless peripheral devices, as a controller for wireless peripheral devices, and/or as a wireless repeater for peripheral and other devices.

According to a fourth aspect there is provided a game for playing on a host computer, the game comprising an auxiliary portion of the a keyboard for releasable and operative attachment to a main keyboard portion, the operative attachment being by a cable, the main keyboard portion comprising a processor and a driver usable for operation of the auxiliary portion, the auxiliary portion being required for the playing of the game of the host computer.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is perspective view of a typical computer system using a first embodiment of a keyboard;

FIG. 2 is a top view of the keyboard of FIG. 1 in a first configuration;

FIG. 3 is a top view of the keyboard of FIG. 1 in a second configuration;

FIG. 4 is a block diagram of the keyboard of FIGS. 1 to 3;

FIG. 5 is a perspective view corresponding to FIG. 1 using a second embodiment of a keyboard;

FIG. 6 is a top view of the keyboard of FIG. 5;

FIG. 7 is a top view of a third embodiment of keyboard; and

FIG. 8 is a top view of a fourth embodiment of keyboard.

### DETAILED DESCRIPTION OF THE PREFERRED EMBODIMENTS

Throughout the drawings like reference numerals are used for like components with the addition of a prefix number designating the embodiment number.

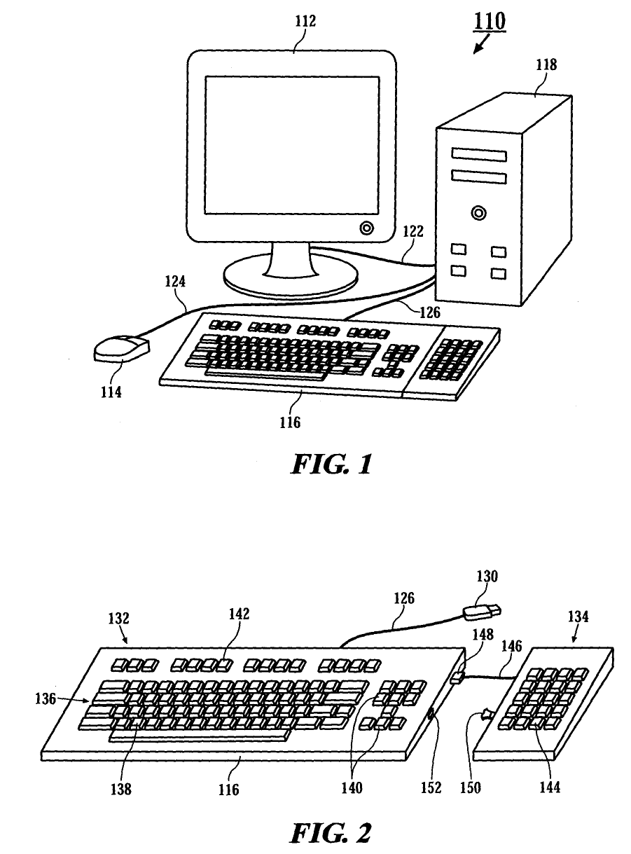

To first refer to the first embodiment of FIGS. 1 to 3, there is shown a standard computer system 110 comprising a monitor 112, a mouse 114, a keyboard 116 and a central processor unit 118. The monitor 112, mouse 114 and keyboard 116 are connected to the central processor unit 118 by cables 122, 124 and 126 respectively. Keyboard cable 126 has a connector 130 at an outer end thereof. The connector 130 may be any suitable connector such as, for example, a USB connector, IEEE 1394 connector, or a proprietary multi-pin connector.

The keyboard 116 has two portions—a main portion 132 and an auxiliary portion 134. The main portion 132 contains a plurality of keys 136 that comprise the main alphanumeric keypad 138, the cursor control keys 140, and function keys 142.

The auxiliary portion 134 contains keys 144 and is operatively connected to the main portion 132 by a cable 146 that has a connector 148 at its end. The connector 148 may be of any known form of connector including, but not limited to RCA, USB, IEEE 1394, or a proprietary multi-pin connector.

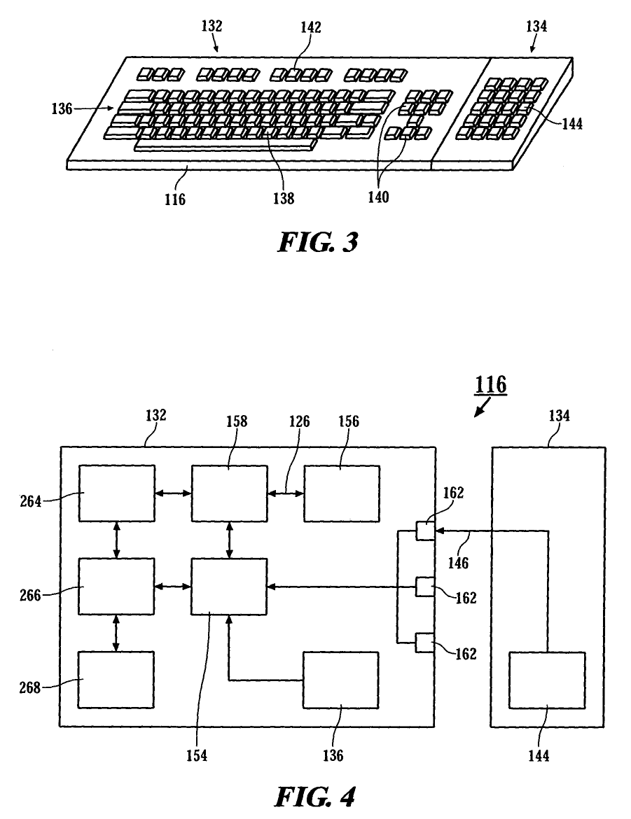

If required or desired, one or more latches may be provided to releasably hold the portions 132, 134 together. Each latch may comprise projections 150 on the auxiliary portion 134 each of which is to engage in a corresponding recess 152 in the manner of a releasable snap fit so as to releasably hold auxiliary portion 134 engaged with main portion 132 as is shown in FIGS. 1 and 3.

Cable 146 is to communicate the signals from keys 144 to a keyboard driver 154 of the main portion 132. As is clear from FIG. 4, the auxiliary portion 134 contains no electronics other than keys 144 and in particular does not have a processor or driver. The driver for keys 144 is driver 154. All power for auxiliary portion 134 is obtained from main portion 132 via cable 146.

The main portion 132 also contains an interface 156 for the cable 126 and the CPU 118. It also has a processor 158 for controlling the keyboard 116, including both the main portion 132 and auxiliary portion 134.

The connector 148 engages in a port 160 of main portion 132. Port 160 may include an interface 162 to detect the presence of connector 148 and to interface with auxiliary portion 134. There may be more than one interface 162 and corresponding port 160 to enable a plurality of different auxiliary portions 134 to be operatively connected to main portion 132 separately or simultaneously.

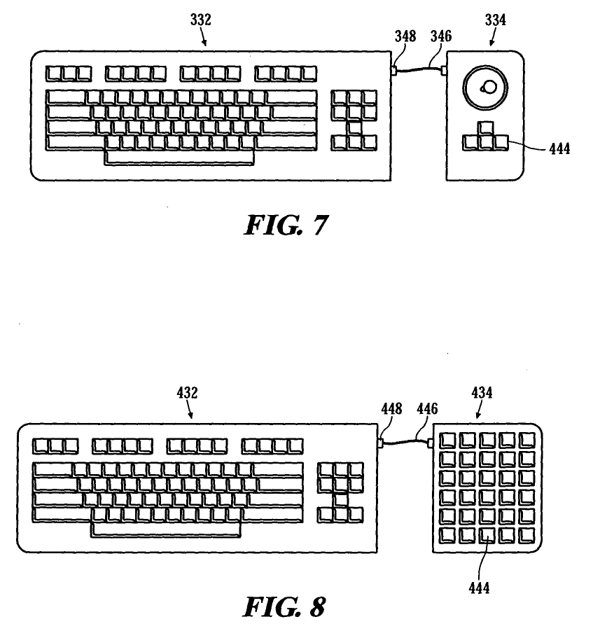

The nature of auxiliary portion 134 may vary. As shown in FIGS. 1 to 4 it is a numeric keypad 162 as would be used by accountants or the like. However, it may be a specialized keypad for Internet telephony 262 (FIG. 6), a games console 334 with cursor control keys and/or joystick (FIG. 7); or a keypad 462 for a character-based language such as, for example, Arabic, Hebrew, Hindi, Chinese Korean, Japanese, and so forth (FIG. 8). Portion 162 may be a scientific keypad, or may be specifically created for a particular application or game. This would enable games and/or applications to be supplied with auxiliary portions 134 that are tailored to the requirements of the game and/or applications. The games console 334 may be able to accept game cartridges/discs or may only have at least one built-in game. The game console 334 may be only a controller such as, for example, a gamepad. Sound generation devices such as, for example, electronic drums, electronic string modules, and so forth may also be incorporated in the auxiliary portion 134. Alternatively, a touch pad, trackball or any other cursor controller may also be incorporated in the auxiliary portion 134.

If the keypad 162 of auxiliary portion 134 requires a new device driver, that can be downloaded using host computer 110 by means of CD-ROM, over the Internet, thumbdrive, or the like.

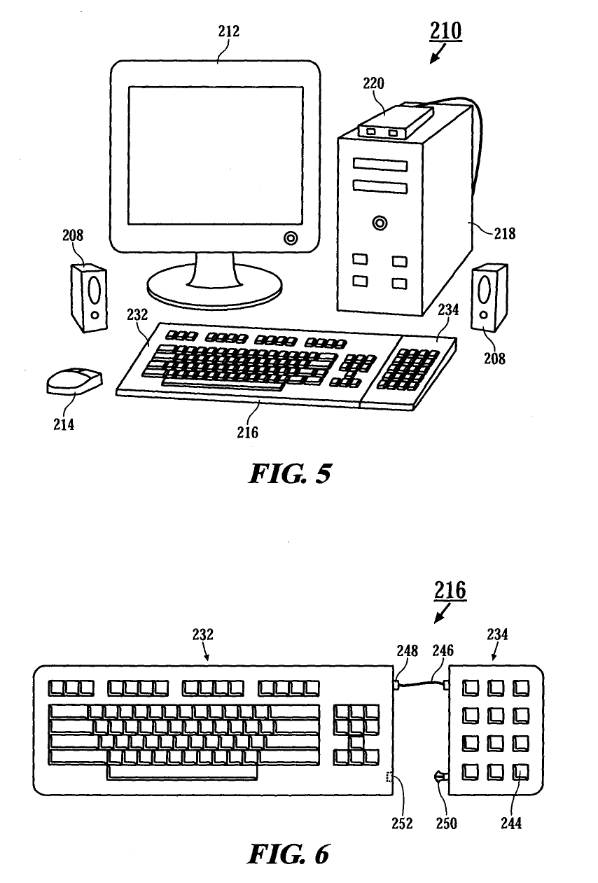

FIGS. 5 and 6 show a variant where the computer system 210 has a keyboard 216 that communicates wirelessly with host computer 218 using a wireless hub 220. Wireless hub 220 may be in-built or separate (as shown). System 210 also includes a pair of speakers 208 that also are wireless enabled.

In this case, and as shown in FIG. 6, there is still the cable 246 and connector 248, as well as the projection(s) 250 and recess(es) 252. Again, all electronics required for auxiliary portion 234 (apart from keys 244) are not in auxiliary portion 234 but are in main portion 232. For this embodiment, and as shown in FIG. 4, the main portion 232 will require a wireless interface 264, transceiver 266 and antenna 268 of known construction and, apart from the description below, known operation.

Preferably, the keyboard 216 uses UltraWide Band for communication with host computer 218 and more preferably is at a frequency in the range 5 GHz or 5.2 GHz. The data transmission rate may be 480 MB/s thus providing a relatively high bandwidth and a workable range of up to 20 meters.

The keyboard 216 may be used as the wireless interface for peripherals with host computer 218. Examples of peripherals include the mouse 214, speakers 208 and monitor 212. The peripherals communicate with the keyboard 216 at a frequency in the range 27 MHz to 49 MHz, and at a bandwidth that is less than bandwidth with which the keyboard 216 communicates with host computer 218. As such, no buffer is required in keyboard 216 and thus communication speed is increased. This also enables the keyboard 216 to be used as a hub for peripheral devices, as a wireless repeater for peripheral and other devices, and/or as a controller for peripheral devices. Peripheral devices may include, for example, speakers 208, monitor 212, mouse 114, and so forth. As UltraWide Band is bidirectional, the repeater functionality may also be bidirectional.

Therefore, it is possible to have the host computer 218 in one room (e.g. study), and the keyboard 216 in an adjacent room (e.g. living room) with the keyboard 216 communicating wirelessly with the host computer 218. The keyboard 216 could also communicate wirelessly with the speakers 208 when in the same room as the speakers 208. In this way the keyboard 216 can be used as the wireless interface for the speakers 208 and can be used to control the speakers 208. In this way the audio for speakers 208 is sent from host 218 to the keyboard 216, and from the keyboard 216 to the speakers 208. The host 218 may also control the speakers 208 through the keyboard 216.

Naturally, speakers 208 could be any other wireless-enabled peripheral.

Whilst there has been described in the foregoing description preferred embodiments of the present invention, it will be understood by those skilled in the technology concerned that many variations or modifications in details of design or construction may be made without departing from the present invention.

1. A keyboard for use with a host computer, the keyboard comprising:
a main portion comprising a processor, a driver, a wireless interface, a transceiver and an antenna; and
an auxiliary portion without an auxiliary portion processor and auxiliary portion driver, the auxiliary portion being releasably connected to the main portion and being operatively connected to the processor by a cable;
wherein
the processor and the driver of the main portion being used for operation of the auxiliary portion, the auxiliary portion being powered by the main portion via the cable;
the keyboard being able to be used at a first bandwidth in a manner selected from the group consisting of: as a hub for wireless peripheral devices, as a controller for wireless peripheral devices, and as a wireless repeater for peripheral and other devices; and
the first bandwidth being for communicating with a host computer.

2. A keyboard as claimed in claim 1, wherein the wireless interface, the transceiver and the antenna are for communicating wirelessly with the host computer and for communicating wirelessly with at least one peripheral device; wherein communication with the at least one peripheral device is at a second bandwidth, the second bandwidth being less than the first bandwidth; and wherein the communication with the host computer is at a first frequency and the communication with the at least one peripheral device is at a second frequency, the first frequency being greater than the second frequency.

3. A keyboard is claimed in claim 2, wherein the first frequency is in the range 5 GHz to 5.2 GHz, the second frequency is in the range 27 MHz to 49 MHz.

4. (canceled)

5. A keyboard as claimed in claim 1, further comprising at least one latch for releasably attaching the auxiliary portion to the main portion.

6. A keyboard as claimed in claim 1, wherein the auxiliary portion comprises at least one selected from the group consisting of: a plurality of keys, a games console, a sound generation device, a touchpad, a trackball and a joystick.

7. A keyboard as claimed in claim 1, wherein the first bandwidth is 480 MB/s.
